(19) United States
(12) Patent Application Publication
(10) Pub. No.: US 2005/0161542 A1
(43) Pub. Date: Jul. 28, 2005

(54) Method of manufacturing refiner elements

(76) Inventor: Patrick J. Theut, Tomahawk, WI (US)

Correspondence Address: GRAY, PLANT, MOOTY, MOOTY & BENNETT, P.A., P.O. BOX 2906, MINNEAPOLIS, MN, 55402-0906, US

(21) Appl. No.: 10/503,878

(22) PCT Filed: Feb. 7, 2003
(86) PCT No.: PCT/US03/03696

Related U.S. Application Data
(60) Provisional application No. 60/355,329, filed on Feb. 7, 2002.

(51) Int. Cl. B02C 7/12

(52) U.S. Cl. 241/298

(57) ABSTRACT

An improved method for the manufacture of a solid disc rotor and/or rotor segment for a single disk refiner, double disk refiner, multi-disk refiner, single cone refiner, or a double cone refiner. The invention comprises a plurality of blades spaced apart by recessed locations of a base plate. Either a water jet milling machine or a horizontal gang mill or both may be used. The blades comprise appropriately dimensioned cold rolled and cryogenically stabilized stainless steel or other appropriate stock of the appropriate hardness required by the application. The blades fit into respective locations in the base. The invention is further characterized by a continuous laser weld (85) along either side of each respective blade at its junction with the base, a variety of possible blade and base materials, and the use of one or more of cryogenic treatment, water cut jetting and water jet milling technologies.

### CROSS REFERENCE TO RELATED APPLICATION

This application claims the benefit of US provisional patent application No. 60/355,329 filed Feb. 7, 2002.

### TECHNICAL FILED

The invention relates to fiber processing equipment utilized in the wood pulp, paper, and rubber industries. More particularly, the invention relates to the manufacture of any of a solid rotor or disk, segmented rotor or stator, single cone rotor or stator, or double cone rotor or stator, all for a refiner.

### BACKGROUND

Paper can be manufactured from a variety of materials. Rags or cotton linters, for example, are used for the highest quality paper. Lower quality paper can be made from seed fibres, jute, flax, grass and other plants. The largest amount of paper today, however is made from wood pulp.

Wood pulp manufacture typically begins with cutting trees, trimming the cut trees into logs and de-barking the logs to provide the raw wood material. The logs are then broken into chips. The chips are then screened to obtain a plurality of chips of a given size. In the case of pressurized ground-wood and conventional ground wood, this chipping procedure is eliminated and replaced with the de-barked logs being ground directly into a pulp slurry. Subsequent to this chipping phase, the chips are either cooked into a pulp slurry and then to a refiner or passed directly into a refiner where the chips are converted into a pulp slurry. The slurry in any of the cases is then washed, screened, and/or bleached. The washed and/or bleached pulp is then passed onto a second refiner or a series of refiners that beat the pulp to a desired degree. Degree is the description of converting a fibre in its raw state which appears under microscopic examination to be shaped similar to a broom-stick and after each step of the refining process the fibre is converted into a structure that appears to resemble a mature corn stalk. One skilled in the art will appreciate that the refining process affects the length of the fibers, their plasticity and their capacity for bonding together during the papermaking process. The quality of the finished product is determined more at the time of refining than at any other time in the paper production process other than on the “table.” At the conclusion of the refining process, the pulp “stock” is suitable for introduction into the papermaking process.

Different types of refiners are known. Some refiners are provided with single cone shaped beater rolls or double cone shaped beater rolls in a similarly shaped housing. Other refiners are provided with substantially round discs. Some disc refiners provide one rotating and one stationary disc, whereas others provide two or more rotating and stationary discs. The discs face one another and, through rotation of one or both discs, frictionally engage the stock to refine the pulp. U.S. Pat. No. 3,984,057 (the entirety of which is incorporated by reference), for example, describes a refiner with three coaxial discs; the other discs are stationary and the intermediate disc is rotated by a power driven shaft.

The pulp-engaging face of any refining disc or cone is conventionally provided with a plurality of spaced refining blades, each of a predetermined thickness, height, and angular position as determined by the fiber processed and the desired future state of the respective fibre. Dams are also conventionally provided within the spaces so as to better process the stock by forcing the stock over the bars. The arrangement of the blades and dams is in part, dictated by the type of wood fiber to be process (i.e., hard, soft or otherwise) as well as by the desired parameters for the resulting end product, be it pulp or wood stock. It is therefore to be understood that, in operation of a refiner, a mixture of wood fiber pulp or chips is delivered to the mass chamber and directed between at least two discs or cones, engaged by the blades and dams thereof and, by friction, torn, shredded, or ground into pulp.

The manufacturing process currently employed for producing a refining disc, cone, or segment is both slow and complex. This is particularly so for an intermediate rotor disc, because it has two refining faces as well as cones. One method of manufacturing a refining disc, segment, or cone element is to cast the element (and blade pattern) as one solid piece. Typical materials for this method are carbon steel, iron, cobalt alloys or stainless steel. Regardless of material, the blades and dams must be machined or tooled in order to assure precise alignment, angular relationship and proper blade/dam configuration. A related method calls for the production of a frame consisting of two or more concentric rings interconnected by spaced, radial extending rods. The blades and dams are fixed, usually by MIG welding, to the frame. Alternatively, a plurality of steel plates may first be fixed to the frame, and then the blades and dams may be fixed to the plates. Of course, for a double face disc the process is done two times and a single face disc the process is done once. These methods have several disadvantages, many of which are explained in U.S. Pat. No. 3,614,826. Any foundry method of manufacture is a lengthy process. This particular foundry process is labor intensive, requiring skilled workmanship. In addition, the casting process results in plates and blades that are brittle and dull easily due to the amorphous nature of a casting regardless of the Rockwell hardness or coating.

Those skilled in the art will appreciate that the cutting action or refining efficiency of a refiner depends, in large part on the number and sharpness of blades; the more blades per given area, the stronger and more efficient the attrition action of the disc. Thus, another disadvantage with these prior art methods is that it is relatively impossible to cast a refiner disc with tall and/or thin blades spaced closely together or in complicated patterns. This results in poor stock distribution and processing.

Another method of manufacturing refiner discs was developed in response to these disadvantages. Specifically, the refiner discs have been manufactured by MIG or Stick welding stainless or carbon steel blades onto a base in the pattern or arrangement desired as demanded by the type of pulp. To manufacture a one or two-sided rotor disc, blades are MIG or Stick welded to one or both sides of the base. Specifically, the blades are individually MIG or Stick welded along one side of their bottom edges so as to be fixed securely to the base. The result of MIG or Stick welding is that the hardness of the welded blades is significantly reduced thus reducing the life of the element and negatively impacting the quality of the pulp fiber produced over time. The completed disc, the whether one-sided or two sided, is secured within the refiner in the conventional manner of bolting.

Still another method of manufacturing refiner elements is the utilization of a frame and sintering process with this process limited by the degree of patterns available due to the limitations of this cost prohibitive process.

The MIG or Stick welding process is a lengthy process, requiring skilled workmanship. The heat generated by the welding process softens the blades, resulting in a decrease in the useful life of the refining disc. Further, the blade-by-blade welding process is expensive in terms of materials, limited in the type of materials available for welding, time intensive and manpower intensive.

According, there is a need for a less expensive method to manufacture in terms of labor, time, and materials costs; more efficient in terms of cutting strength, pulp stock distribution and fibre treatment, conserves energy and other refiner operating costs, and offers an increase in useful performance lifetime.

### SUMMARY OF THE INVENTION

The invention solves the above-described problems in the prior art by providing a combination water jet cutting and laser welded element that preserves the original hardness of the blade elements and significantly increases the range of available patterns, and blade materials and construction; and also reduces the energy, time and labor cost to manufacture. As a result, the life and operating efficiency of the element area is increased.

Generally described, the invention comprises at least one, and typically a plurality of, refining blade(s) positioned in recessed regions of a base. The recessed regions are preferably pre-cut grooves or pre-drilled holes. The blades may comprise mating features such as tabs for fitting into the recessed locations. This produces proper spacing of the respective blades depending on the element involved. The blades are fixedly secured to the base using a laser welding system to provide a completed refiner element. Of course, dams may be provided to enhance the refining capability of the element. If provided, the dams are preferably also laser welded to the base.

The blades of the invention have a height matched to the pulp being refined. Thus, the bar height may be of any height as required and can be easily modified depending on the refining needs. This is not done as easily with a casting process if a higher blade is required due to the pattern change required along with the resulting weakening of the blade. If a lower height bar is required, it is not easily done with the conventional MIG/Stick welded plate process, as the welding process softens the blade. Thus, one major advantage of the invention is the application matching of the element construction to the pulp.

A second major advantage of the invention is maximizing the type of blade material and construction, which increases the life of the element and maximizes the development of the pulp.

A third major advantage is a significant reduction in manufacturing costs in terms of electrical energy, time, labor, and materials.

A fourth major advantage is improved hardness of the blade, thus improving element life expectancy and increased tearing efficiency. This is because the laser welding does not heat up the blade to the degree of other welding processes Thus, the invention provides an improved refining element for use in refiners of pulp or other types of fibrous stock used in papermaking and related industries. An improved refining disc having simplified manufacture conserves time, labor, and energy, and allows for application matching of blade and base materials. An improved refiner element results in better stock distribution and consistent fiber treatment by the refiner. Also conserves energy both in operation, and in the manufacture of the element. It provides a longer useful performance lifetime due to the materials of construction. It has a decreased time to manufacture, which meets the JIT demands of the industry. The improved refining element has blades that maintain their original degree of hardness, and are comprised of materials and construction matched to the application. The improved refining element enjoys the benefits of a laser/waterjet manufacturing process, but overcomes shortcomings in such a process.

### BRIEF DESCRIPTION OF THE DRAWINGS

Each of the Figures is schematic in nature to illustrate the invention in visual terms, but the scope of the invention should be limited to the illustrated embodiment except as specifically provided in the claims.

FIGS. 1 to 4 are each schematic process diagram of the process aspect of the invention as applied to the production of various refiner fillings. FIG. 1 illustrates fabrication of a disk segment; FIG. 2 illustrates fabrication of a solid disk; FIG. 3 illustrates fabrication of a conical plate; and FIG. 4 illustrates fabrication of a bar which is a sub-process to produce a component of each of FIGS. 1-3.

FIG. 5 is a schematic perspective view of three preferred types of bars manufactured and used in accordance with the invention: a straight bar with tabs, a straight bar, and a curved bar with tabs (such as would be typically used with a cone refiner).

FIG. 6 is a schematic side view of a pattern of recessed regions formed in a cone refiner.

FIG. 7 is the schematic perspective view of a segmented base plate produced according to the invention, such as would be cut by either water jet milling or gang saws.

FIGS. 8 and 9 are schematic perspective and side views, respectively, of the use of laser welding at the junctions or other locations where the base metal and bar metal are joined or melted together.

FIGS. 10-12 are schematic views of three styles of finished product according to the invention. FIG. 10 is a face view of a disk segment; FIG. 11 is a face view of a flat disk; and FIG. 12 is perspective view of a matched pair of cone refiners.

### DETAILED DESCRIPTION

In general terms, the invention discloses an improved method for the manufacture of a solid rotor disc and/or rotor segment for a single disk refiner, double disk refiner, multi-disk refiner, single cone refiner, or a double cone refiner. The invention comprises a plurality of blade members spaced apart by recessed locations of a base plate. Such locations are preferably grooves cut into, or selectively spaced holes drilled into, the base plate material by either a water jet milling machine, or a horizontal gang mill, or both.

In the case of disks and segments, the base plates are preferably cut to dimension using CAD/CAM driven water jet cutting technology so as to avoid warping and localized hardening or localized softening of the blades. The blades are cut out of appropriately dimensioned cold rolled and cryogenically stabilized stainless steel or other appropriate stock of the appropriate hardness required by the application through CAD/CAM using either a high wattage CO₂ or YAG laser, or water jet. The blades for the cone-based refiners are cut in such a way that a mating feature, preferably an alignment tab, is cut into the blades in a way that allows the respective blade to fit into the respective predrilled tab location in the conic base.

In forming the preferred disc, segment, or cone, the plurality of blades are placed into recessed regions such as the grooves or holes in the base plate(s), preferably one at a time while the base plates or cones are fixed on a turnstile. The respective plate or cone is then swung into position and the respective blade is affixed to the base plate or cone using high wattage (about three kilowatts or more) CO₂ or YAG laser attached to a robot driven by CAD/CAM.

Thus, in one aspect, the invention is characterized by the presence of a mounting plate or base member, the use of the latest CO₂ and YAG laser welding equipment and water jet milling technology, and the lack of need for weld material. The method of the invention is characterized by a continuous laser weld along either side of each respective blade, the ability to use a variety of possible blade and base materials, and the blending of cryogenic treatment and waterjet cutting and water jet milling technology.

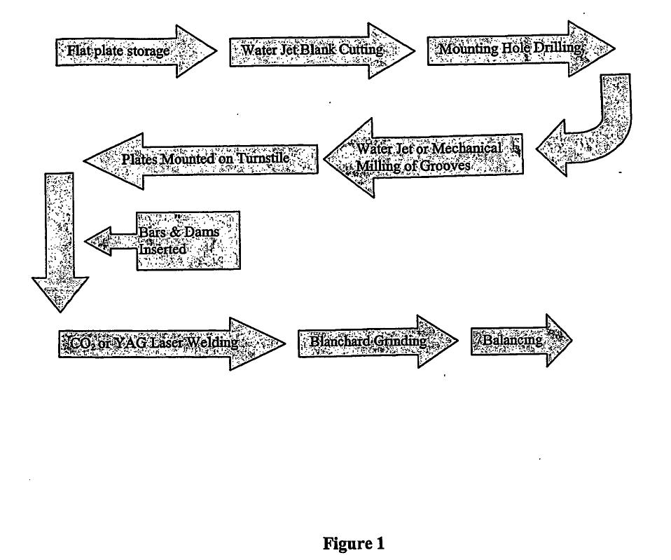

Referring to FIGS. 1-4, the various process described above are schematically arranged to reflect the process of manufacturing refiner plates, disks, or cones. In FIGS. 1-4, as in all the Figures, some steps or features not necessarily essential to specific embodiments of the invention are shown by way of example or illustration or convenience only.

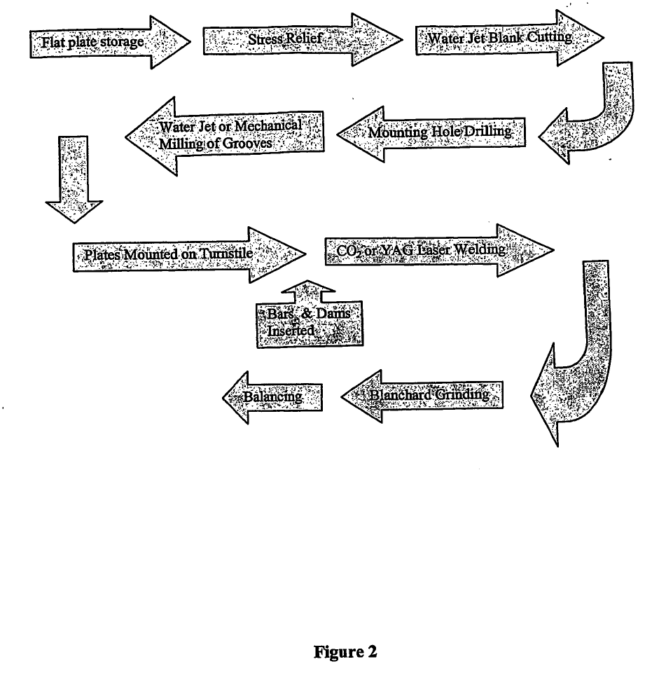

The base steel flat plate for either a disk segment (FIG. 1) or an entire disk (FIG. 2) is taken from storage and placed into the water jet cutting machine. The respective disk or segment is then cut out. The water jet cutting machine has more than one cutting head (e.g., four heads) so as to minimize cutting time. It is preferable to then press the cut elements flat. Then, mounting holes are water jet or laser cut into the cone for bar mounting purposes.

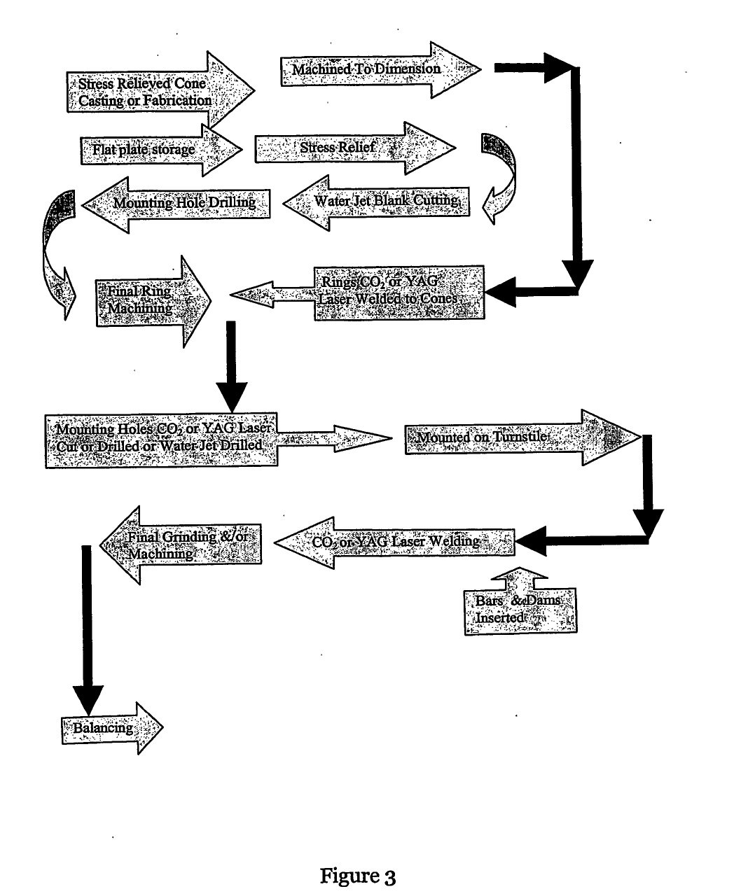

In the case of cones (FIG. 3), they are cast (typically in a different facility) or otherwise fabricated to produce a stress relieved cone, which is then and machined or otherwise dimensioned to net shape. In a process similar to that used for disk segments or entire disks described immediately above, mounting rings are water jet cut at the same time and then inserted and welded onto the respective cones. Then, mounting holes are water jet or laser cut into the cone for bar mounting purposes.

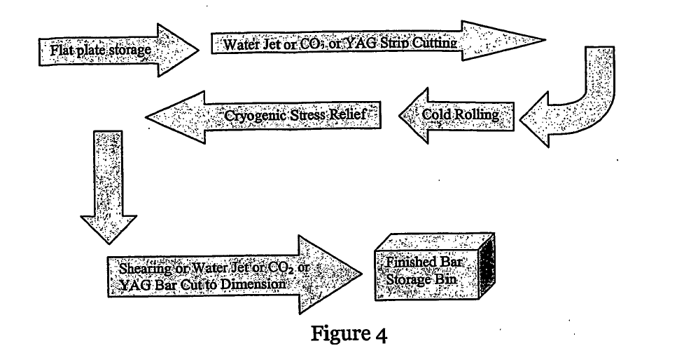

The bars and either disks, disk segments in the full circle condition, or cones with rings are then brought together at a turnstile. At the turnstile the bars (manufactured as described in association with FIG. 4, below) are inserted in the respective base and then swung into position so as to be laser welded. As one bar is being welded, the operator is inserting a bar in the approximately 180 degrees opposite position to maintain balance and thus efficiency of the turnstile approach. Once welded, the turnstile moves and swings into position the most recently inserted bar for welding. This process is repeated until the respective disk/full circle segment/cone is completed.

If dams are inserted, the respective disk, full circle segment, or cone is left in the turnstile and the dams are inserted and welded in a process similar to that of the bars.

The disk, full circle segment, or cone is then cryogenically treated for stress relief, then Blanchard ground or machined to tolerance. Those disks, full circle segments or cones that spin in operation spin are subsequently balanced to tolerance after the completion of the stress relief, grinding, or machining. The respective disk, full circle segment, or cone is now complete and ready for packaging/shipping/installation.

For each of the processes above, as indicated schematically in FIG. 2, the bar steel is placed into the water jet cutting machine and the respective plates of bar stock are cut out. The bars may be pre-hardened material depending on the application. If not, the cut out plates are cold rolled to the proper thickness and hardness. The cold rolled plates are then cryogenically treated. The plates are then either water jet or laser cut to dimension. The final cut bars are then binned according to size for the respective plate pattern.

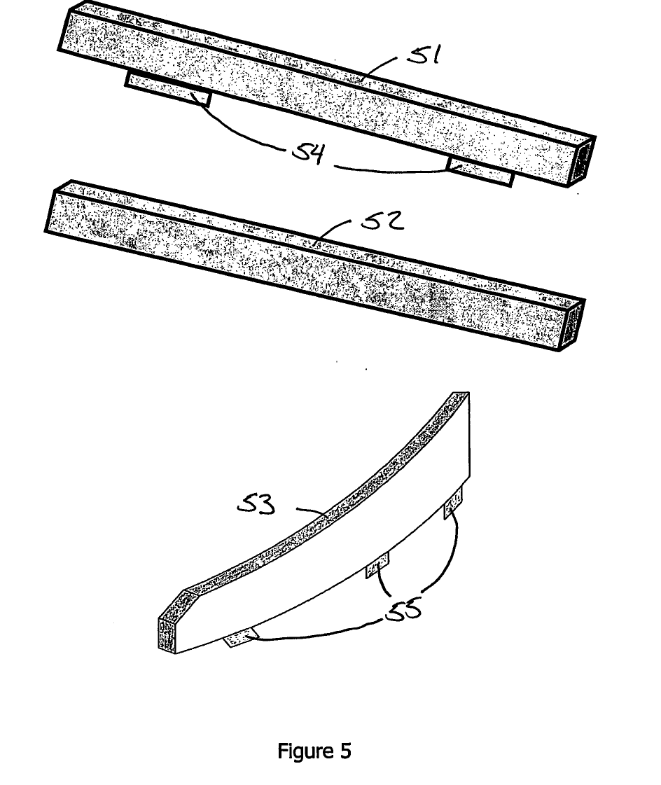

FIG. 5 illustrates the three respective bar types. Straight bar 51 is cold rolled to thickness, stress relieved, and then cut to final dimension. All bars have the similar design with the leading edge taper. Straight bar 52 and curved bar 53 are cold rolled to thickness, stress relieved, and then cut straight with knobs 54 or in an arc so as to match with the arc of the cone with the addition of knobs to final dimension. This bar 53 also typical has the leading edge taper.

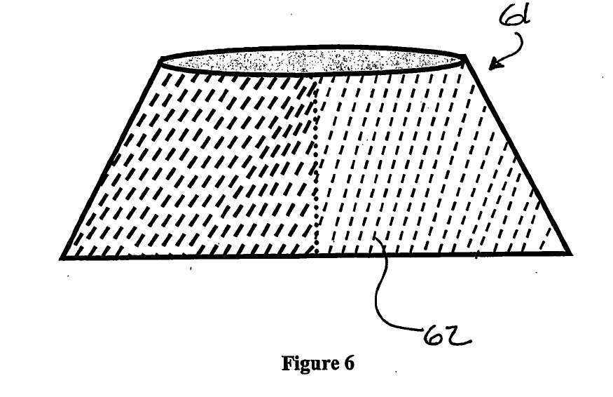

FIG. 6 schematically shows the result of the laser cutting or waterjet cutting/milling of a cone 61. Holes 62 are water drilled (for example) in a helical pattern that matches the arc required to support knobs 55. In some cases, a helix is not required.

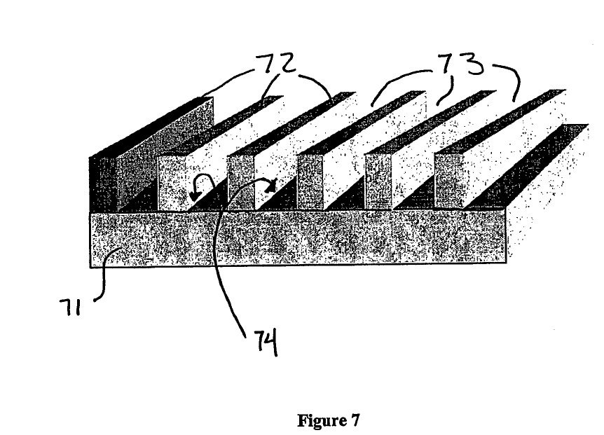

FIG. 7 is a schematic partial cross-section of a portion of a core, full circle segment, or disk. Base 71 supports a plurality of bars 72 and thus defines groves 73.

In FIG. 7, the grooves 73 are cut with a square shoulder 74 in all cases. This is only a preference. In either the case of water jet milling or gang cutting, preferably numerous grooves 73 are cut simultaneously so as to minimize shop time.

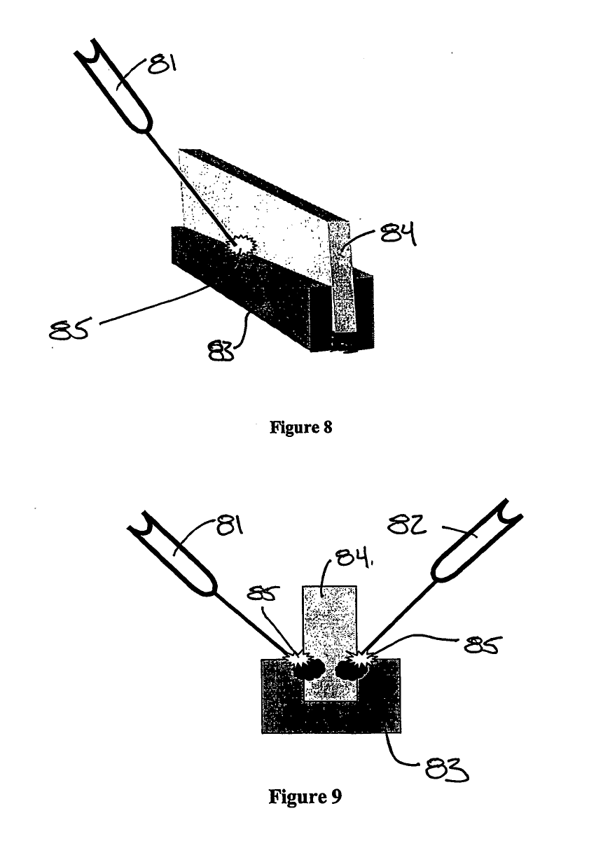

FIGS. 8 and 9 schematically show the process of laser welding and the resultant metal penetrations. FIG. 8 illustrates a single laser AD1, while FIG. 9 illustrates a pair of lasers 81 and 82 which if used, are operated simultaneously in the preferred embodiment. Base 83 supports bar or blade 84 while lasers 81 (and 82 if used) weld the components together in a continuous laser weld 85 that preferably extends along the entire junction between bar or blade 84 and base 83.

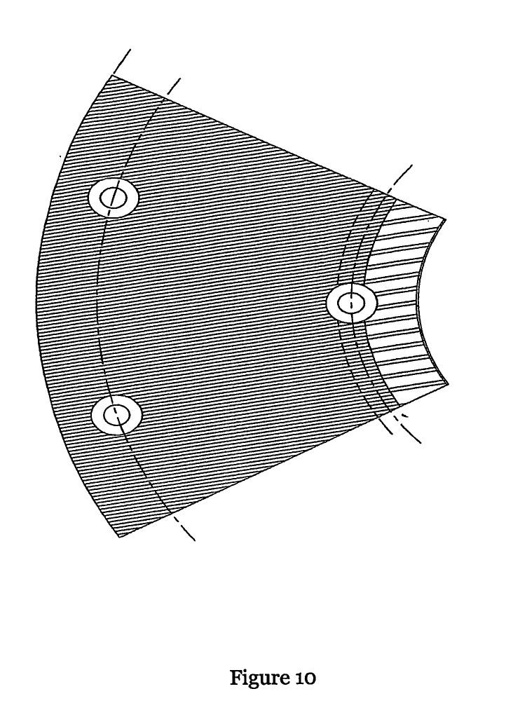

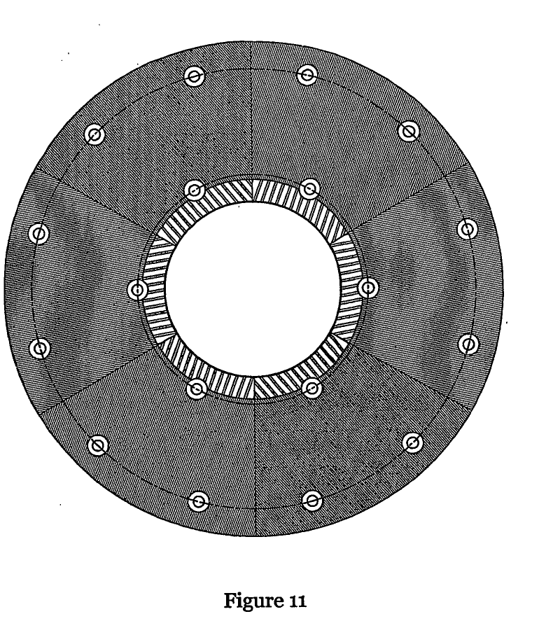

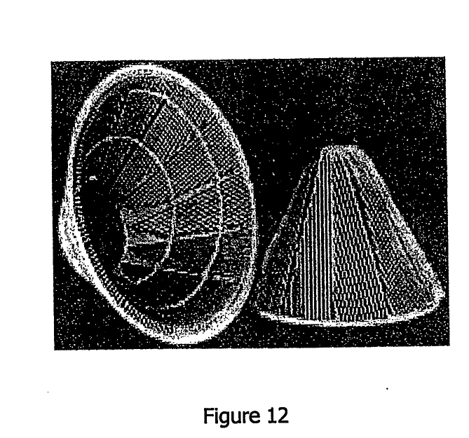

FIGS. 10-12 illustrate examples of the three types of finished product, namely the full circle segment (FIG. 10), the full disk (FIG. 11), and the cone (FIG. 12). The particular shapes, angles, and other features are not limitations on the scope of the invention and are for illustration purposes only.

The invention has been described above in a manner understandable to the person skilled in the relevant art, and therefore it should be understood against the background of at least the following documents, the entireties of all of which are incorporated by reference: U.S. Pat. No. 505,806 (Allfree); U.S. Pat. No. 874,244 (Robinson); U.S. Pat. No. 2,760,624 (Compton); U.S. Pat. No. 2,807,871 (Wagner et al.); U.S. Pat. No. 3,614,826 (Pilao); U.S. Pat. No. 3,984,057 (Pilao); U.S. Pat. No. 4,157,669 (Pilao); U.S. Pat. No. 4,624,420 (Pilao); U.S. Pat. No. 4,681,270 (Oberhofer); U.S. Pat. No. 4,827,588 (Meyer); U.S. Pat. No. 4,874,136 (Webster); U.S. Pat. No. 4,951,888 (Sharpe et al.); U.S. Pat. No. 5,178,339 (Pilao); U.S. Pat. No. 5,249,734 (Pilao); U.S. Pat. No. 5,354,005 (Mladota); U.S. Pat. No. 5,580,472 (Maybon); U.S. Pat. No. 5,586,531 (Maybon); U.S. Pat. No. 5,740,972 (Matthew); U.S. Pat. No. 5,954,283 (Matthew); and U.S. Pat. No. 6,402,067 (Webster); also Japanese patent 1,252,388; Brazilian patent 7500262; and German patent 76167.

1. A refiner element for pulp materials, comprising at least one refining blade positioned in a recessed region of a base and fixedly secured to the base by a laser weld.

2. The refiner element of claim 1, in which the laser weld extends continuously along an entire junction between the refining blade and the base.

3. The refiner element of claim 1, in which the refiner element is selected from the group consisting of a disk segment, a disk, and a conical refiner.

4. The refiner element of claim 1, in which the laser weld is performed with one of a CO₂ or YAG laser.

5. The refiner element of claim 1, in which a refining blade comprises a mating feature that fits into a respective location of the base.

6. The refiner element of claim 1, in which the refining blades comprise cold rolled, cryogenically stabilized stainless steel.

7. The refiner element of claim 1, in which the refining blades have been cut to dimension by a water jet process.

8. The refiner element of claim 1, in which the refiner element is cryogenically treated for stress relief after laser welding.

9. The refiner element of claim 1, in which the refiner element is brought to tolerance after laser welding by Blanchard grounding or machining.

10. The refiner element of claim 1, in which the refiner element is spin balanced to tolerance after the completion of any stress relief, grinding, or machining

11. A process of manufacturing a refiner element for pulp materials, comprising
providing a base having at least one recessed region,
positioning at least one refining blade in a recessed region of the base that mates with the refining blade, and
welding the blade to the base with a laser weld.

12. The process of claim 11, in which the welding comprises extending the laser weld continuously along an entire junction between the refining blade and the base.

13. The process of manufacturing a refiner element of claim 11, in which the refiner element is selected from the group consisting of a disk segment, a disk, and a conical refiner.

14. The process of manufacturing a refiner element of claim 11, in which the laser weld is performed with one of a CO₂ or YAG laser.

15. The process of manufacturing a refiner element of claim 11, in which a refining blade comprises a mating feature that fits into a respective location of the base.

16. The process of manufacturing a refiner element of claim 11, in which the refining blades comprise cold rolled, cryogenically stabilized stainless steel.

17. The process of manufacturing a refiner element of claim 11, in which the refining blades have been cut to dimension by a water jet process.

18. The process of manufacturing a refiner element of claim 11, in which the refiner element is cryogenically treated for stress relief after laser welding.

19. The process of manufacturing a refiner element of claim 11, in which the refiner element is brought to tolerance after laser welding by Blanchard grounding or machining.

20. The process of manufacturing a refiner element of claim 11, in which the refiner element is spin balanced to tolerance after the completion of any stress relief, grinding, or machining.
